(19) United States
(12) Patent Application Publication
(10) Pub. No.: US 2020/0302459 A1
(43) Pub. Date: Sep. 24, 2020

(54) METHODS AND SYSTEMS FOR COMPUTING INTERCHANGE RATE DESIGNATOR FOR A PAYMENT TRANSACTION

(71) Applicant: Mastercard International Incorporated, Purchase, NY (US)

(72) Inventor: Saumitra Sanjay Chepe, Pune (IN)

(73) Assignee: Mastercard International Incorporated, Purchase, NY (US)

(21) Appl. No.: 16/808,658

(22) Filed: Mar. 4, 2020

(30) Foreign Application Priority Data
Mar. 18, 2019 (SG) 10201902410P

(51) Int. Cl. G06Q 30/02; G06Q 40/02; G06Q 30/00; G06Q 20/40; G06Q 30/04; G06F 16/2455

(52) U.S. Cl. CPC G06Q 30/0206; G06Q 40/02; G06Q 30/0185; G06F 16/24558; G06Q 20/405; G06Q 30/04; G06Q 30/0236

(57) ABSTRACT

Embodiments provide a methods and systems to eliminate or make optional the computation of IRD value for the acquiring bank or the issuing bank. The method includes receiving, by a server system, at least one transaction clearing file for at least one payment transaction from at least one of an acquiring server or an issuing server. The transaction clearing file comprises a data field for an IRD value, an acquiring BIN and an issuing BIN. The method further includes determining whether the data field for IRD value in the at least one transaction clearing file comprises an identifier or an empty space indicating request for determination of the IRD value. The method further includes computing the IRD value for the at least one payment transaction upon determining that IRD value data field comprises the identifier or the empty space.

### CROSS REFERENCE TO RELATED APPLICATIONS

This application claims priority to Singaporean Application No. 10201902410P, filed Mar. 18, 2019, which is incorporated herein by reference in its entirety

### TECHNICAL FIELD

The present disclosure relates to digital payment transaction technology and, more particularly to, computation of interchange rate designator (IRD) value for payment transactions.

### BACKGROUND

The cashless payment transactions have become a common and preferable practice for any kind of transactions nowadays. Users are increasingly using card-based payment as compared to the cash payment whether it is for shopping, business deals, bill payments, availing services etc. In a conventional card payment system, a payment card is issued by an issuing bank in which cardholder has an account. The cardholder can purchase products or services using the payment card. When the cardholder presents the payment card at a merchant terminal such as a point of sale (POS) terminal or online payment interface associated with the merchant in order to pay for purchase transactions, a purchase request is sent to an acquirer which is handling merchant's account. The acquirer sends the transaction request to a payment server for authorization of the payment transaction. The payment server receives authorization requests for purchase transactions from the acquirer and routes the requests to the issuer of the payment card. The issuer authorizes the payment transaction by checking whether the cardholder's account is in good standing and whether the transaction amount of the purchase is covered by the cardholder's available account balance.

The payment server further performs the settlement of transactions between issuers and acquirers. In order to facilitate card-based payment transaction between the issuing and acquiring institutions, an interchange fee is introduced for the card payment process and the interchange fee is normally paid by the acquiring bank or the issuing bank. An interchange fee is imposed to reimburse the cost of providing payment card services and processing payment card transactions. Interchange fee also covers the inherent risk in the issuing bank's role in a payment card transaction. Specifically, in a dual-message system setup or in a credit card payment, the issuing bank does not debit the cardholder's account balance immediately, instead, it provides funds to the merchant on behalf of the cardholder and assumes that the cardholder will pay when the payment card statement comes due. Accordingly, the interchange fee is imposed, at least in part, to cover the possibility that a cardholder will fail to or be unable to reimburse the issuing bank.

Interchange fee is generally computed based on an interchange rate designator (IRD) value. The IRD value for a particular transaction may vary significantly based on a plurality of characteristics of the payment transaction such as, but not limited to, whether the payment card transaction was made with a debit or credit card, the amount of the transaction, the nature of the goods and services purchased, whether the transaction was conducted online or at a brick and mortar location, the payment program or service enrolled by the merchant, whether the transaction was processed entirely electronically, and the location of the transaction (e.g., domestic or international).

The determination of IRD value is a very complicated and cumbersome task because it is based on different business service rules and some parameters like type of transaction, amount of transaction, merchant category code (MCC), product type, etc. Based on the IRD value, the payment server determines which interchange rate to apply for the transaction and the amount to which the payment server is entitled during a settlement or clearing process.

In the present scenario, the acquirer and issuer are responsible for computing the IRD value for each transaction and share the IRD value with the payment server in a clearing file. Processing of interchange fee presents various problems and inefficiencies. For instance, the acquiring bank may identify or insert an invalid or incorrect IRD. Due to such errors, an inflated charge may be assessed to be levied upon the merchant as the IRD fee or may have a risk of transaction failure due to non-processing of transaction data. If transaction data is rejected, correcting and reprocessing the transaction data may require significant time and network bandwidth, leading to unnecessary costs for the acquiring bank. Moreover, the payment server also validates the IRD value provided by the acquirer or issuer using certain algorithms for determination of IRD value based on business service rules and other parameters related to the payment transaction. So, this is a redundant process.

In light of the above, there exists a need for eliminating redundancy and inefficiencies in processing interchange rates in a payment processing network.

### SUMMARY

Various embodiments of the present disclosure provide methods and systems for making IRD value determination optional for the acquiring bank or the issuing bank and further providing discount on the interchange fee charged from the acquiring bank or the issuing bank by the payment server upon determining that the acquiring bank or the issuing bank belongs to same-party network as the payment server.

In an embodiment, a method is disclosed. The method includes receiving, by a server system, at least one transaction clearing file for at least one payment transaction from at least one of an acquiring server and an issuing server. The acquiring server is associated with an acquiring bank, and the issuing server is associated with an issuing bank. The at least one transaction clearing file includes an IRD value data field, an acquiring bank-identification (BIN) data field, and an issuing BIN data field. The method further includes determining, by the server system, whether the IRD value data field in the at least one transaction clearing file comprises at least one of an empty space, an identifier or an IRD value. The identifier and the empty space indicates request from the at least one of the acquiring server and the issuing server for determination of the IRD value. The method further includes computing, by the server system, the IRD value for the at least one payment transaction upon determining that the IRD value data field comprises at least one of the identifier or the empty space.

In another embodiment, a server system is disclosed. The server system includes a memory configured to store instructions and at least one processor configured to execute the stored instructions to cause the server system to perform a method. The method includes receiving, by the server system, at least one transaction clearing file for at least one payment transaction from at least one of an acquiring server and an issuing server. The acquiring server is associated with an acquiring bank, and the issuing server is associated with an issuing bank. The at least one transaction clearing file includes an IRD value data field, an acquiring bank-identification (BIN) data field, and an issuing BIN data field. The method further includes determining, by the server system, whether the IRD value data field in the at least one transaction clearing file comprises at least one of an empty space, an identifier or an IRD value. The identifier and the empty space indicates request from the at least one of the acquiring server and the issuing server for determination of the IRD value. The method further includes computing, by the server system, the IRD value for the at least one payment transaction upon determining that the IRD value data field comprises at least one of the identifier or the empty space.

In yet another embodiment, another method is disclosed. The method includes receiving, by a server system, at least one transaction clearing file for at least one payment transaction from at least one of an acquiring server and an issuing server. The acquiring server is associated with an acquiring bank, and the issuing server is associated with an issuing bank. The at least one transaction clearing file includes an IRD value data field, an acquiring bank-identification (BIN) data field, and an issuing BIN data field. The method further includes determining, by the server system, whether the IRD value data field in the at least one transaction clearing file comprises at least one of an empty space, an identifier or an IRD value. The identifier and the empty space indicates request from the at least one of the acquiring server and the issuing server for determination of the IRD value. The method further includes computing, by the server system, the IRD value for the at least one payment transaction upon determining that the IRD value data field comprises at least one of the identifier or the empty space. The method further includes identifying, by the server system, whether the at least one of the acquiring bank and the issuing bank is a registered member with the server system. The registered member indicates that the at least one acquiring bank and the at least one issuing bank is using application provided by the server system. Upon identification of registration of the at least one of the acquiring bank and the issuing bank with the system server, the method includes generating, by the server system, a discount on an interchange fee charged from the at least one of the acquiring bank and the issuing bank.

Other aspects and example embodiments are provided in the drawings and the detailed description that follows.

### BRIEF DESCRIPTION OF THE FIGURES

For a more complete understanding of example embodiments of the present technology, reference is now made to the following descriptions taken in connection with the accompanying drawings in which:

FIG. 1 illustrates an exemplary representation of an environment related to at least some example embodiments of the present disclosure;

FIGS. 2A and 2B illustrate a sequence flow diagram representing a method for making IRD value determination optional for the acquiring bank or the issuing bank and for generating discount on an interchange fee, in accordance with an example embodiment;

FIG. 3 illustrates a simplified block diagram of a server system used for making IRD value determination optional for the acquiring bank or the issuing bank and further generating discount on the interchange fee, in accordance with an example embodiment;

FIGS. 4A and 4B illustrate examples of format of the transaction clearing file, in accordance with an example embodiment;

FIGS. 5A and 5B illustrate a flow diagram of a method for making IRD value determination optional for the acquiring bank or the issuing bank and further generating discount on the interchange fee, in accordance with an example embodiment;

FIG. 6 illustrates a flow diagram of another method for making IRD value determination optional for the acquiring bank or the issuing bank, in accordance with example embodiment;

FIG. 7 is a simplified block diagram of a merchant terminal or a POS terminal used for facilitating the payment transaction, in accordance with an example embodiment;

FIG. 8 is a simplified block diagram of an issuing server, in accordance with an example embodiment;

FIG. 9 is a simplified block diagram of an acquiring server, in accordance with an example embodiment;

FIG. 10 is a simplified block diagram of a payment server, in accordance with an example embodiment; and

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” “one example embodiment”, “an embodiment” or “an example embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “issuing server” used herein refers to a server that holds a financial account that is used to fund the financial transaction (interchangeably referred to as “card payment transaction”) of a cardholder. Further, the term “acquiring server” used herein refers to a server that holds a financial account of a merchant or any entity which receives the fund from the issuing server. Examples of the issuing server and the acquiring server include, but are not limited to a bank, electronic payment portal such as PayPal®, and a virtual money payment portal. The financial accounts in each of the issuing server and the acquiring server may be associated with an entity such as an individual person, a family, a commercial entity, a company, a corporation, a governmental entity, a non-profit organization and the like. In some scenarios, the financial account may be a virtual or temporary payment account that can be mapped or linked to a primary payment account, such as those accounts managed by PayPal®, and the like.

The term “payment card”, used herein, refers to a physical or virtual card linked with a financial or payment account that may be presented to a merchant or any such facility in order to fund a financial transaction via the associated payment account. Examples of the payment card include, but are not limited to, debit cards, credit cards, prepaid cards, digital wallet, virtual payment numbers, virtual card numbers, forex card, charge cards and stored-value cards. A payment card may be a physical card that may be presented to the merchant for funding the payment. Alternatively or additionally, the payment card may be embodied in form of data stored in a user device, where the data is associated with payment account such that the data can be used to process the financial transaction between the payment account and a merchant's financial account.

The term “payment server”, used herein, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by Mastercard®, VISA®, Discover®, American Express®, etc.

Overview

Various embodiments of the present disclosure provide methods and systems to eliminate or to make optional the computation of IRD value for the acquiring bank or the issuing bank. More specifically, embodiments provide techniques to provide IRD value data field in a transaction clearing file as an optional field instead of a compulsory field.

In an example scenario, a cardholder may offer to pay for goods purchased at a merchant facility using a payment card. The merchant facility may be a physical store such as, a retail establishment or an online store. The cardholder presents his payment card to an agent at a merchant terminal for initiating a payment transaction. If the payment transaction is initiated for the online store, the cardholder provides payment card information during check out from the online store on a payment page (hosted by the online store). The merchant sends a transaction message to an acquiring bank. The transaction message includes a purchase amount of the product/service purchased during the payment transaction and details of the payment card presented by the cardholder. The acquiring bank identifies a payment server associated with the payment card. The acquiring bank generates a transaction clearing file for the payment transaction and sends the transaction clearing file along with an authorization request to the payment server.

The payment transaction can be authorized and settled according to the single message system or dual message system. In the single message system, the acquiring bank will send a transaction clearing file for each transaction individually at the time of the payment transaction along with the authorization request. In dual message system, the acquiring bank first only sends the authorization request to the payment server for authorization/approval from the issuing bank and clearing/settlement of the payment transaction happens later. The issuing bank receives the authorization request and performs authorization check and accordingly sends approval/decline for the payment transaction. In dual message system, post-authorization the issuing bank holds amount in the cardholder's account equivalent to the purchase amount. The amount is deducted or released post clearing/settlement of the payment transaction.

In the dual message system, the merchant prepares a batch of a plurality of payment transactions at the end of each day and sends the batch to the acquiring bank. The acquiring bank prepares a plurality of transaction clearing files respective to the plurality of payment transactions. The acquiring bank sends the plurality of transaction clearing files to the payment server. The payment server segregates the plurality of transaction clearing files according to the respective issuing bank and accordingly generate transaction clearing file for each issuing bank.

The transaction clearing file includes an IRD value data field, an acquiring BIN data field, an issuing BIN data field and other details related to the payment transaction such as purchase amount, type of product, merchant type, type of payment card, mode of payment etc. The IRD value data field is provided as an optional data field and hence IRD value data field can include one of an identifier or an IRD value applicable for the payment transaction, or the IRD value data field can be empty. The identifier corresponds to a code indicating that the acquiring bank requests to the payment server for determination of the IRD value for the payment transaction. However, in some cases, instead of the identifier, the empty IRD value data field can also indicate that the acquiring bank is requesting the payment server to determine the IRD value. Hence, the IRD value data field is optional for the acquiring bank. Similarly, the IRD value data field is optional for the issuing bank in cases where the issuing bank sends a transaction clearing/settlement file to the payment server, for example, a cashback transaction, a refund processing transaction etc.

Alternatively or additionally, the IRD value data field further includes two sub-data fields. The two sub-data fields include a first sub-data field and a second sub-data field, wherein the first sub-data field includes a single value IRD flag whose high value (i.e. value 1 or “Y”) indicates that the second sub-data field contains IRD value which is already determined by the acquiring bank or the issuing bank. The low value (i.e. value 0 or “N”) of the IRD flag indicates that the second sub-data field is empty and the acquiring bank or the issuing bank requests the payment server to determine the IRD value. The second sub-data field is an optional field which may or may not include the IRD value.

The payment server reads the IRD value data field and accordingly determines whether to determine the IRD value or validate the given IRD value provided by the acquiring bank. If the IRD value data field contains the IRD value, then the payment server performs validation of the received IRD value. If the IRD value data field does not contain the IRD value, then the payment server determines the IRD value. The payment server charges interchange fee from the acquiring bank as well as the issuing bank for the services provided by the payment server including the determination of IRD value.

In at least one example embodiment, the payment server further identifies the acquiring bank identification number (BIN) and issuing BIN from the transaction clearing file. When the acquiring bank and the issuing bank are registered with the payment server, the payment server assigns the acquiring BIN and the issuing BIN to the acquiring bank and the issuing bank, respectively. Bank Identification Numbers (BINs), which are the first six digits of the account number, are fundamental to payments. The BINs are used to identify the issuing bank or the acquiring bank for the account and ensure that each transaction is routed correctly. Each payment server for example, but not limited to, Mastercard®, VISA®, Discover®, American Express®, etc., has a pre-defined BIN range (pre-defined acquiring BIN ranges and pre-defined issuing BIN ranges) from which a BIN is assigned to the acquiring banks and issuing banks during registration. The pre-defined acquiring BIN ranges and issuing BIN ranges are stored in a database of the payment server.

The payment server identifies whether the acquiring bank belongs to same-party network or third-party network based on matching the acquiring BIN and issuing BIN with the pre-defined acquiring BIN ranges and issuing BIN ranges. For example, if the payment server is Mastercard® and the acquiring BIN belongs to VISA® then it will be third-party network or “third-party acquirer”. Further, the payment server is Mastercard® and the acquiring BIN also belongs to Mastercard® then it will be considered as the same-party network or “same-party acquirer”. Similarly, whether the issuing bank belongs to same-party network or third-party network can also be identified from the issuing BIN. When the payment server identifies that the acquiring bank or the issuing bank are same-party network, the payment server generates a discount on the interchange fee charged for the determination of the IRD value and other service provided by the payment server. The payment server reduces the interchange fee according to the generated discount.

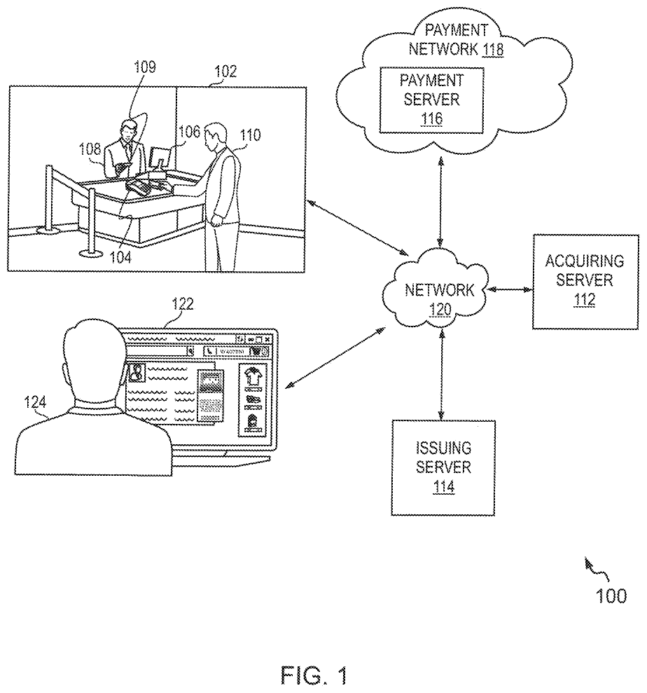

Various example embodiments of present invention are described hereinafter with reference to FIGS. 1 to 10.

FIG. 1 illustrates an exemplary representation of an environment 100 related to at least some example embodiments of the present disclosure. The environment 100 is exemplarily shown as a merchant facility 102 (also referred to herein as ‘a merchant 102’) equipped with a merchant terminal 104 (also referred to as ‘a POS terminal 104’) and a merchant interface device 106. The merchant terminal 104 comprises either the POS terminal 104 or an online interface for e-commerce transactions. Examples of the merchant facility 102 may include any retail establishments such as, restaurant, supermarket or business establishments such as, government and/or private agencies, toll gates, parking lot or any such place equipped with POS terminals, such as the merchant terminal 104 where users (e.g., cardholders) visit for performing financial transaction in exchange for any goods and/or services or any transaction that requires financial transaction between users and a merchant. In various embodiments, the merchant interface device 106 can be a telephone or a computer system operated by an agent 108 for performing payment transactions on behalf of a user, for example, a cardholder 110. As seen in FIG. 1, the merchant interface device 106 is a computer system operated by the agent 108. It shall be noted that herein the merchant terminal 104 refers to a POS machine which is used to swipe payment cards and not the entire setup including, cash drawers, printers and barcode scanners.

The environment 100 also exemplarily depicts a cardholder 124 associated with a cardholder device 122. Examples of the cardholder device 122 include, but are not limited to, a personal computer (PC), a tablet device, a personal digital assistant (PDA), a smartphone and a laptop. The cardholder 124 may access an e-commerce website interface (online store) facilitated by the merchant 102 on the device 122. It shall be noted that the term ‘merchant terminal’ may also refer to the online store of the merchant 102.

In an example scenario, the cardholder 110 may purchase goods from the merchant 102 and offer to pay for the goods using a payment card 109. In conventional scenarios, the cardholder 110 would reach the merchant terminal 104 upon his turn and hand over the payment card 109 to the agent 108. The agent 108 may swipe the payment card 109 at the merchant terminal 104 that may display a prompt requesting the cardholder 110 to provide a PIN for authorizing the transaction using the payment card 109. For example, when the agent 108 swipes the payment card 109 at the POS terminal 104, the card reader module reads the payment card information and prompts the cardholder 110 to provide the PIN for validating the transaction. The cardholder 110 provides the PIN on the POS terminal 104. The merchant terminal 104 sends transaction details to an acquiring server 112. The transaction details include the payment card information, the PIN and a transaction amount among other details such as merchant identifier and merchant account details. The acquiring server 112 forwards the transaction details to a payment server 116. The payment server 116 sends the payment card information and the PIN to an issuing server 114 for verification.

The issuing server 114 verifies whether the PIN received from the payment server 116 is an actual PIN linked to an associated issuer account of the cardholder 110 for which the payment card 109 was issued to the cardholder 110. The issuing server 114 further checks the account balance of the issuer account and whether the account balance is enough to accommodate the transaction amount. Based on these determinations, the transaction request may be facilitated. The issuing server 114 sends a transaction approval or decline notification/message to the payment server 116. The payment server 116 sends the transaction approval or decline notification/message to the acquiring server 112. The acquiring server 112 sends the transaction approval or decline notification/message to the POS terminal 104. The POS terminal 104 generates a bill or a receipt for transaction. The bill may include the transaction amount, taxes, transaction date, POS ID information, issuing bank name and acquiring bank name, among other information. The bill is printed at the POS terminal 104. The bill is handed over to the cardholder 110.

The payment server 116 facilitates the card payment transaction by the transfer of information between the acquiring server 112 and the issuing server 114 via a network 120 and also performs clearing/settlement of the payments between the acquiring server 112 and the issuing server 114.

It shall be noted that the acquiring server 112 is associated with a financial institution normally called as a “merchant bank” or the “acquiring bank” or “acquirer bank” or simply “acquirer”, in which the merchant 102 may have a merchant account. The issuing server 114 is associated with a financial institution normally called as an “issuing bank” or “issuer bank” or simply “issuer”, in which the cardholder 110 may have an account. The acquiring server 112 is associated with the acquiring bank. The terms “acquiring server” and the “acquiring bank” are herein used interchangeably. Similarly, the “issuing server” and the “issuing bank” are herein used interchangeably. Using the payment network 118, the acquiring server 112 will communicate with the issuing server 114 to determine whether the cardholder's account is in good standing and whether the transaction amount of the purchase is covered by the cardholder's available account balance. Based on these determinations, authorization of the transaction is declined or accepted. When the authorization is accepted, the available balance of cardholder's account is decreased.

In at least one embodiment, the merchant 102 generates a batch of a plurality of payment transactions performed at its POS terminal 104/merchant terminal 104 in a business day at end of the business day and sends the batch to the acquiring server 112. The acquiring server 112 generates a transaction clearing file for each payment transaction of the batch and sends the generated plurality of transaction clearing files to the payment server 116. The payment server 116 receives the plurality of transaction clearing files from the acquiring server 112 and segregates the plurality of transaction clearing files into groups of transaction clearing files belonging to respective issuing server 114 and accordingly generate transaction clearing file for each issuing server 114.

The transaction clearing file includes IRD value data field, acquiring BIN data field, issuing BIN data field and other details related to the payment transaction such as purchase amount, type of product, merchant type, type of payment card, mode of payment etc. The IRD value data field is provided as optional data field and hence IRD value data field can include one of an identifier or an IRD value applicable for the payment transaction or the IRD value data field can be empty. The identifier corresponds to a code indicating the acquiring server 112 requests to the payment server 116 for determination of the IRD value for the payment transaction. However, in some cases, instead of the identifier, the empty IRD value data field can also indicate that the acquiring server 112 is requesting the payment server 116 to determine the IRD value. Hence, the IRD value data field is optional for the acquiring server 112. Similarly, the IRD value data field is optional for the issuing server 114 in cases where the issuing server 114 sends a transaction clearing/settlement file to the payment server 116 for example, a cashback transaction, a refund processing transaction etc.

Alternatively, or additionally the IRD value data field further comprises two sub-data fields a first sub-data field and a second sub-data field, wherein the first sub-data field comprises a single value IRD flag whose high value (i.e. value “1” or “Y”) indicates that the second sub-data field contains IRD value which is already determined by the acquiring server 112. The low value (i.e. value “0” or “N”) of the IRD flag indicates that the second sub-data field is empty and the acquiring server 112 requests the payment server 116 to determine the IRD value. For the sake of simplicity, a single-value IRD flag is considered however more than one value IRD flag may also be present on the first sub-data field.

The payment server 116 reads the IRD value data field from the transaction clearing file. The payment server 116 determines whether the IRD value data field includes an identifier that indicates request for determination of IRD value for the payment transaction. Alternatively, the payment server 116 determines that the acquiring server 112 is requesting for determination of IRD value based on empty IRD value data field. Alternatively, or additionally, the payment server 116 determines that the first sub-data field includes a low value (i.e. value “0” or “N”) of the IRD flag and accordingly determines that the acquiring server 112 is requesting for determination of IRD value.

Upon determining that the acquiring server 112 requests for determination of the IRD value, the payment server 116 determines the IRD value for the payment transaction. The payment server 116 determines the interchange fee based on the IRD value determined for the payment transaction. However, if the IRD value data field includes the IRD value provided by the acquiring server 112, then the payment server 116 validates the IRD value provided by the acquiring server 112.

In another example scenario, the payment server 116 facilitates registration of the acquiring server 112 and the issuing server 114 with the payment server 116. The payment server 116 assigns an acquiring BIN to the acquiring server 112 and issuing BIN to the issuing server 114 during the registration. Bank Identification Numbers (BINs), which are the first six-digits of the account number, are fundamental to payments. They identify the issuing bank or the acquiring bank for the account and ensure that each transaction is routed correctly. Each payment server for example, but not limited to, Mastercard®, VISA®, Discover®, American Express®, etc. has a pre-defined BIN range (pre-defined acquiring BIN ranges and pre-defined issuing BIN ranges) from which a BIN is assigned to the acquiring banks and issuing banks during registration. For example, in a non-limiting manner, Mastercard® has range of 2-series numbers (range 222100-272099) and range of the 5-series numbers (range 510000-559999). These acquiring BIN ranges and issuing BIN ranges are stored in a database of the payment server 116. Based on the acquiring BIN and issuing BIN, the payment server 116 identifies whether the acquiring server 112 belongs to same-party network or third-party network. For example, if the payment server 116 is Mastercard® and the acquiring BIN belongs to VISA® then it will be third-party network or “third-party acquirer”, or if the acquiring BIN belongs to Mastercard® then it will be same-party network or “same-party acquirer”. Similarly, whether the issuing server 114 belongs to same-party network or third-party network can also be identified from the issuing BIN.

In another example scenario, the same-party acquirer corresponds to for example, but not limited to, the acquiring server 112 using application services provided by the payment server 116 such as an application for handling POS terminal payment transaction received by the acquiring server 112. The third-party acquirer corresponds to for example, but not limited to, the acquiring server 112 using application services provided by a payment server other than the payment server 116 such as the payment server 116 is Mastercard® and the acquiring server 112 using application services of VISA®.

When the payment server 116 identifies that the acquiring server 112 or the issuing server 114 belongs to same-party network then the payment server 116 generates a discount on the interchange fee charged for the determination of the IRD value and other service provided by the payment server 116. The payment server 116 reduces the interchange fee according to the generated discount. The payment server generates a discount on the interchange fee based on a plurality of parameters such as the transaction amount, operating region of the acquiring server 112 and the issuing server 114, type of payment card 109 used in the payment transaction etc. A list of discount rates along with different combination of the plurality of parameters can be stored in a table format for easy access or reference for the payment server 116.

For example, if the interchange fee for the third-party network is an amount ‘x’ then the interchange fee charged from the acquiring bank or issuing bank belonging to the same-party network will be less than the amount ‘x’.

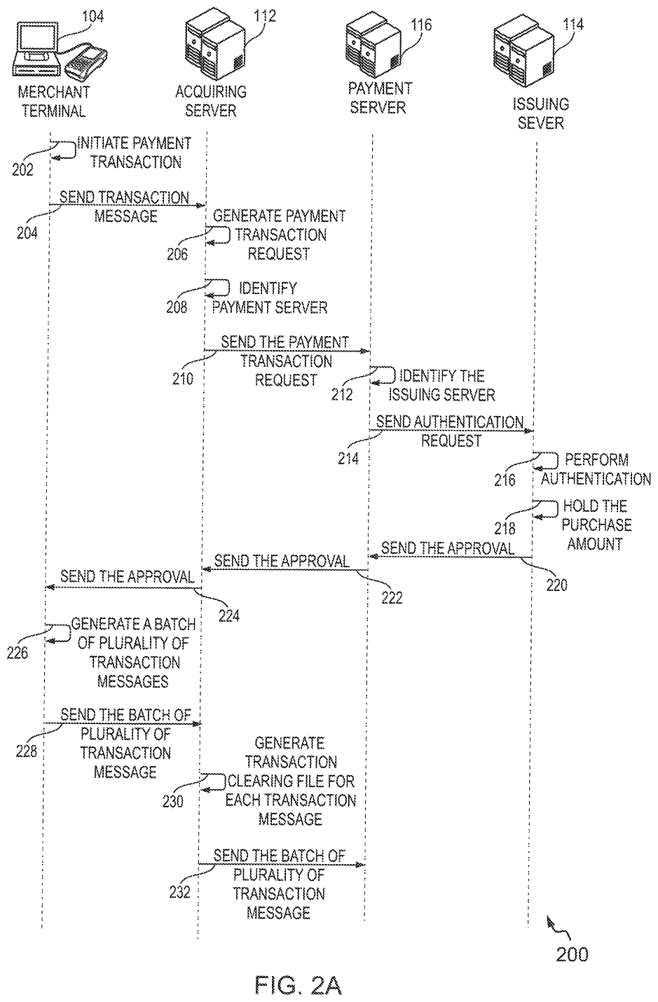

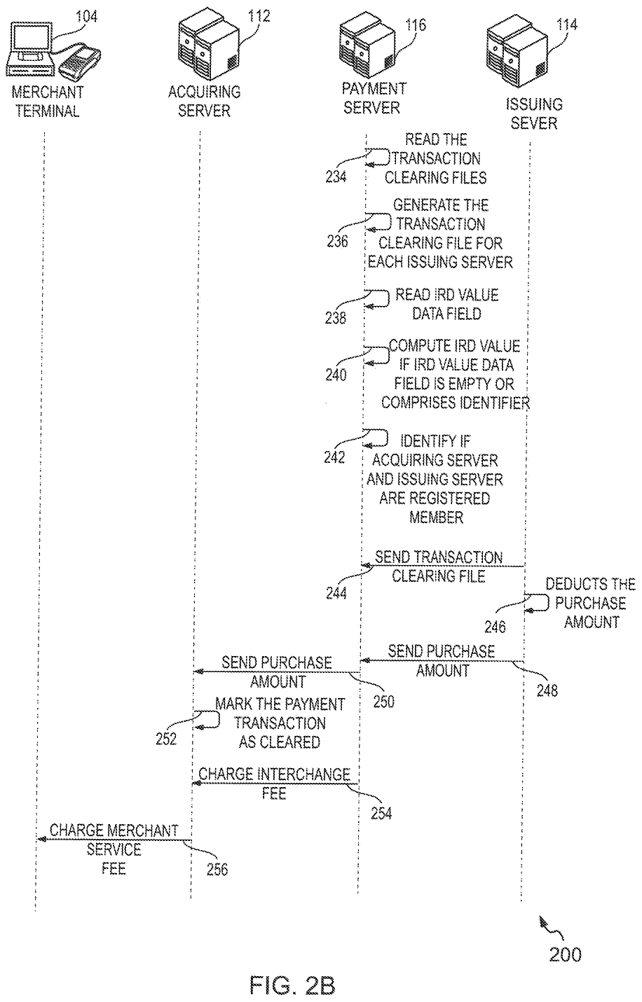

Referring now to FIGS. 2A and 2B, illustrate a sequence flow diagram representing a method 200 for making IRD value determination optional for the acquiring bank 112 or the issuing bank 114. The method 200 further generates a discount on the interchange fee charged from acquiring bank 112 or the issuing bank 114 by the payment server 116 upon determining that the acquiring bank 112 or the issuing bank 114 belongs to same-party network as the payment server 116, in accordance with an example embodiment.

At 202, the cardholder 110 initiates a payment transaction at the merchant terminal 104. The agent 108 at the merchant terminal 104 swipes the payment card 109 at the merchant terminal 104 to read the payment card information. In some example embodiments, the merchant terminal 104 may also be a merchant facilitated e-commerce website interface (online store) running on the cardholder device 122 associated with the cardholder 124. During check-out from the online store, the cardholder 124 provides the payment card information of an associated payment card on a payment page. For example, the cardholder 124 may provide information such as, payment card type, payment card number, name of the cardholder 124, validity of the payment card and any other credentials requested by the payment page.

At 204, the merchant terminal 104 sends a transaction message comprising details of the payment transaction along with details of the payment card 109 to the acquiring server 112.

At 206, the acquiring server 112 generates a payment transaction request based on the transaction message. The payment transaction request includes the payment card information and the purchase amount for the payment transaction. At 208, the acquiring server 112 identifies the payment server 116 associated with the payment card 109. At 210, the acquiring server 112 sends the payment transaction request to the payment server 116 for authentication and approval from the issuing server 114.

At 212, upon receiving the payment transaction request from the acquiring server 112, the payment server 116 identifies the issuing server 114 which issued the payment card 109. At 214, the payment server 116 sends an authentication request for the approval of the payment transaction request received from the acquiring server 112.

At 216, the issuing server 114 performs authentication of the payment transaction request based on few parameters such as account balance of the cardholder 110/124, verifying PIN submitted by the cardholder 110/124 etc. At 218, the issuing server 114 holds the purchase amount of the item purchased during the payment transaction. At 220, the issuing server 114 sends an approval to the payment server 116 for the payment transaction.

At 222, the payment server 116 sends the approval for the payment transaction to the acquiring server 112. At 224, the acquiring server 112 sends the approval message to the merchant terminal 104. The merchant terminal 104 generates a bill or a receipt for transaction. The bill may include the transaction amount, taxes, transaction date, POS ID information, issuing bank name and acquiring bank name, among other information. The bill is printed at the merchant terminal 104. The bill is handed over to the cardholder 110/124.

Steps 202-224 are repeated for each payment transaction occurring at the merchant terminal 104.

At 226, the merchant terminal 104 generates a batch of a plurality of transaction messages respective to plurality of payment transactions at the end of each day. At 228, the merchant terminal 104 sends the batch to the acquiring server 112 or the issuing server 114.

At 230, the acquiring server 112 prepares a plurality of transaction clearing files corresponding to the plurality of transaction messages received from the merchant terminal 104. At 232, the acquiring server 112 sends the plurality of transaction clearing files to the payment server 116. Similarly, the issuing server 112 also prepares the plurality of transaction clearing files corresponding to the plurality of transaction messages received from the merchant terminal 104 and sends the plurality of transaction clearing files to the payment server 116. For the sake of brevity, the invention is explained mainly with respect to the acquiring server 112 with reference of issuing server 114 in few places, however a person ordinary skilled in the art will be able to understand that the disclosure can be extended to include the issuing server in place of the acquiring server for the implementation of the present invention.

The transaction clearing file comprises the IRD value data field, the acquiring BIN data field, the issuing BIN data field and other details related to the payment transaction such as purchase amount, type of product, merchant type, type of payment card, mode of payment etc. The IRD value data field is provided as the optional data field.

At 234, the payment server 116 reads the plurality of transaction clearing files received from the acquiring server 112. The payment server 116 segregates the plurality of transaction clearing files with respect to the respective issuing bank 114 they belong to and accordingly at step 236, the payment server 116 generates transaction clearing file for each issuing bank 114.

At 238, the payment server 116 reads the IRD value data field from the transaction clearing file.

At 240, the payment server 116 computes the IRD value if the IRD value data field in the transaction clearing file is empty or the IRD value data field comprises the identifier. However, if the IRD value is provided by the acquiring server 112 in the transaction clearing file then the payment server 116 validates the given IRD value based on business service rules and certain other parameters such as purchase amount, type of product, merchant type, type of payment card, mode of payment etc.

At 242, the payment server 116 identifies whether the acquiring server 112 and the issuing server 114 are registered with the payment server 116 or not based on the acquiring BIN and the issuing BIN. The payment server 116 identifies the acquiring BIN and issuing BIN from the transaction clearing file.

The payment server 116 identifies whether the acquiring server 112 belongs to same-party network or third-party network based on matching the acquiring BIN and issuing BIN with the pre-defined acquiring BIN range and the pre-defined issuing BIN range respectively. For example, if the payment server is Mastercard® and the acquiring BIN belongs to VISA® then it will be third-party network or “third-party acquirer”, or if the acquiring BIN belongs to Mastercard® then it will be same-party network or “same-party acquirer”. Similarly, whether the issuing server 114 belongs to same-party network or third-party network can also be identified from the issuing BIN. When the payment server 116 identifies that the acquiring server 112 or the issuing server 114 are same-party network then the payment server 116 generates a discount on the interchange fee charged for the determination of the IRD value and other service provided by the payment server 116.

At 244, the payment server 116 sends the transaction clearing file to the issuing server 114 for settlement of the payment transaction. At 246, the issuing server deducts the purchase amount, which was on hold, from the cardholder's account. At 248, the issuing server 114 sends the purchase amount to the payment server 116. At 250, the payment server 116 sends the received purchase amount to the acquiring server 112. At 252, the acquiring server 112 marks the payment transaction as cleared.

At 254, the payment server 116 charges interchange fee for the determination of the IRD value and other service provided by the payment server 116 to the acquiring server 112. Similarly, the interchange fee will be charged from the issuing server 114. However, when the payment server 116 identifies that the acquiring server 112 or the issuing server 114 are same-party network then the payment server 116 reduces the interchange fee charged for the determination of the IRD value and other service provided by the payment server 116. The payment server generates a discount on the interchange fee based on a plurality of parameters such as the transaction amount, operating region of the acquiring server 112 and the issuing server 114, type of payment card 109 used in the payment transaction etc. A list of discount rates along with different combination of the plurality of parameters can be stored in a table format for easy access or reference for the payment server 116. The payment server reduces the interchange fee charged from the at least one of the acquiring server and the issuing server according to the generated discount.

At 256, the acquiring server 112 charges fee such as merchant service fee (MSF) from the merchant 102 to compensate for the interchange fee.

Further, the issuing server 114 charges fee from the cardholder 110/124 to compensate for the interchange fee paid to the payment server 116.

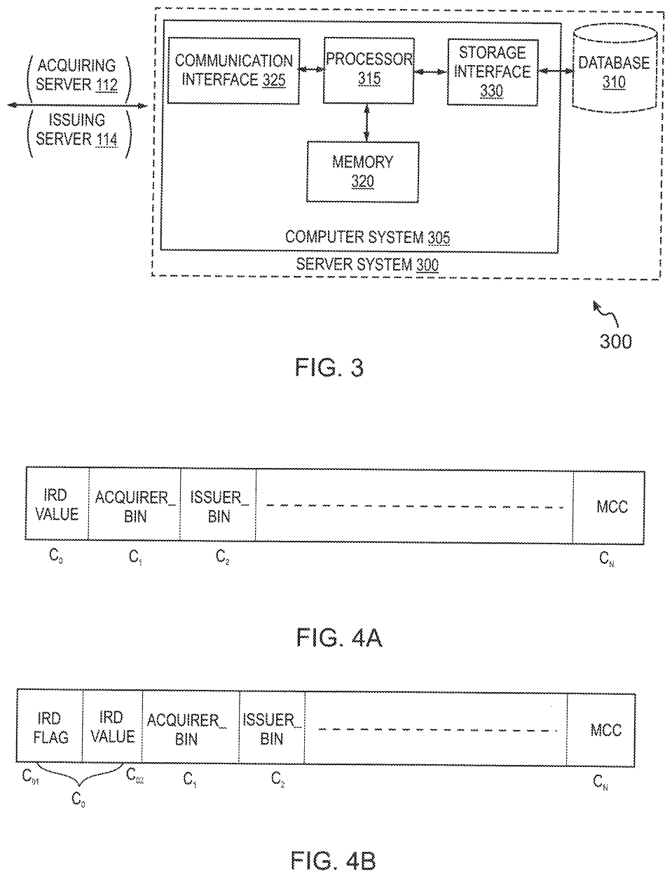

Referring now to FIG. 3, illustrates a simplified block diagram of a server system 300 used for making IRD value determination optional for the acquiring bank 112 or the issuing bank 114 and generating discount on the interchange fee charged from acquiring bank 112 or the issuing bank 114, in accordance with one embodiment of the present disclosure. Examples of the server system 300 include, but are not limited to, the payment server 116. The server system 300 includes a computer system 305 and a database 310.

The computer system 305 includes at least one processor 315 for executing instructions, a memory 320, a communication interface 325, and a storage interface 330. Instructions may be stored in, for example, but not limited to, the memory 320. The processor 315 may include one or more processing units (e.g., in a multi-core configuration).

The processor 315 is operatively coupled to the communication interface 325 such that the computer system 305 is capable of communicating with a remote device such as the acquiring server 112 and the issuing server 114 or communicating with any entity within the payment network 118. For example, the communication interface 325 may receive the plurality of transaction clearing files from the acquiring server 112, the approval message for the payment transaction from the issuing server 114. The communication interface 325 is further configured to send the transaction clearing files to the issuing server 114 and the approval message to the acquiring server 112.

The processor 315 may also be operatively coupled to the database 310. The database 310 is any computer-operated hardware suitable for storing and/or retrieving data, such as, but not limited to, transaction data generated as part of sales activities conducted over the bankcard network including data relating to merchants, account holders or users, and purchases. The database 310 may also store information related to a plurality of user's issuer accounts. Each user account data includes at least one of a cardholder name, a cardholder address, an account number, MPIN, and other account identifier. The database 310 may also store information of a plurality of merchants, plurality of loyalty programs offered by the plurality of merchants, plurality of POS terminals installed at merchant facilities, such as POS ID, etc. The database 310 may also include the pre-defined acquiring BIN ranges and the pre-defined issuing BIN ranges. The database 310 may also include instructions for settling transactions including merchant bank account information. The database 310 may include multiple storage units such as hard disks and/or solid-state disks in a redundant array of inexpensive disks (RAID) configuration. The database 310 may include a storage area network (SAN) and/or a network attached storage (NAS) system.

In some embodiments, the database 310 is integrated within the computer system 305. For example, the computer system 305 may include one or more hard disk drives as the database 310. In other embodiments, the database 310 is external to the computer system 305 and may be accessed by the computer system 305 using a storage interface 330. The storage interface 330 is any component capable of providing the processor 315 with access to the database 310. The storage interface 330 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 315 with access to the database 310.

The processor 315 is configured to facilitate a transaction from an issuer account to an acquirer account (merchant account). The processor 315 is configured to perform one or more functions such as: facilitate registration of at least one of the acquiring bank 112 and the issuing bank 114 with the server system 300; assign acquiring BIN to the registered acquiring bank 112 and assign issuing BIN to the registered issuing bank 114; receive a transaction clearing file from the at least one of the acquiring bank 112 and the issuing bank 114 , read an IRD value data field present in the transaction clearing file; and compute IRD value for the payment transaction if the IRD value data field comprises the identifier indicating a request from the acquiring bank 112 to determine the IRD value for the payment transaction.

The transaction clearing file comprises IRD value data field, acquiring BIN data field, issuing BIN data field and other details related to the payment transaction such as purchase amount, type of product, merchant type, type of payment card, mode of payment etc. The IRD value data field is provided as the optional data field

Thereafter, the processor 315 is further configured to identify whether the acquiring server 112 and the issuing server 114 are registered with the payment server 116 or not, based on the acquiring BIN and the issuing BIN. The payment server 116 identifies the acquiring BIN and the issuing BIN from the transaction clearing file.

The processor 315 identifies whether the acquiring server 112 belongs to same-party network or third-party network based on matching the acquiring BIN and issuing BIN with the pre-defined acquiring BIN ranges and the pre-defined issuing BIN ranges respectively. For example, if the payment server 116 is Mastercard® and the acquiring BIN belongs to VISA® then it will be third-party network or “third-party acquirer”, or if the acquiring BIN belongs to Mastercard® then it will be same-party network or “same-party acquirer”. Similarly, whether the issuing server 114 belongs to same-party network or third-party network can also be identified from the issuing BIN. When the processor 315 identifies that the acquiring server 112 or the issuing server 114 are same-party network then the payment server 116 generated a discount on the interchange fee charged for the determination of the IRD value and other service provided by the payment server 116. The processor 315 further configured to reduce the interchange fee according to the generated discount. The processor 315 generates a discount on the interchange fee based on a plurality of parameters such as the transaction amount, operating region of the acquiring server 112 and the issuing server 114, type of payment card 109 used in the payment transaction etc. A list of discount rates along with different combination of the plurality of parameters can be stored in a table format inside or outside the server system 300 for easy access or reference.

For example, if the interchange fee for the third-party network is an amount ‘x’ then the interchange fee charged from the acquiring bank or issuing bank belonging to the same-party network will be less than the amount ‘x’ let's say an amount “z”. The difference between “x” and “z” will be equivalent to the discount generated by the server system 300.

Thereafter, the processor 315 is configured to facilitate the clearing process of the payment transaction from the issuer account of the cardholder 110 to the acquirer account of the merchant 102. The processor 315 may also be configured to notify the merchant terminal 104 of the transaction status via the communication interface 325.

In an example, the processor 315 may include one or more processors, microprocessors, data processors, co-processors, network processors, application specific integrated circuits (ASICs), controllers, programmable logic devices, chipsets, field programmable gate arrays (FPGAs), and/or some other component(s) that may interpret and/or execute instructions and/or data. The processor 315 may control the overall operation of the server system 300 based on an operating system and/or various applications.

FIGS. 4A and 4B illustrate examples of format of the transaction clearing file, in accordance with an example embodiment.

In FIG. 4A the transaction clearing file comprises, in a non-limiting manner, data fields from C0 to Cn (n=1, 2, 3 . . . ) The data field C0 belongs to IRD value data field, the data field C1 corresponds to acquiring BIN data field and the data field C2 corresponds to issuing BIN and remaining data fields comprises for example, but not limited to, merchant category code, country code, transaction date, a message type indicator (MTI), a transaction amount, a function code, a processing code, a reversal indicator, message reason code, acquiring institution country, a point of sale (POS) data, a universal cardholder authentication field (UCAF) indicator, a service code, transaction currency code, an approval code, and a clearing product ID etc. Please note the sequence of the parameters in the transaction clearing file may vary from what is shown in the FIG. 4A.

The IRD value data field is provided as optional data field and hence IRD value data field can include one of an identifier or an IRD value applicable for the payment transaction or it can be empty. The identifier corresponds to a code indicating the acquiring bank 112 requests to the payment server 116 for determination of the IRD value for the payment transaction. However, the empty IRD value data field can also indicate that the acquiring server 112 is requesting the payment server 116 to determine the IRD value. Hence, the IRD value data field is optional for the acquiring server 112. Similarly, the IRD value data field is optional for the issuing server 114 in cases where the issuing bank sends a transaction clearing/settlement file to the payment server 116 for example, a cashback transaction, a refund processing transaction etc.

Referring now to FIG. 4B, another format of the transaction clearing file is shown. In FIG. 4B the transaction clearing file comprises, in a non-limiting manner, data fields from C0 to Cn (n=1, 2, 3 . . . ) The data field C0 comprises a first sub-data field C01 and a second sub-data field C02. The first sub-data field includes a single value IRD flag and the second sub-data field can optionally include IRD value. Please note that a high value (i.e. value 1 or “Y”) of the IRD flag indicates that the second sub-data field contains IRD value which is determined by the acquiring server 112. The low value (i.e. value 0 or “N”) of the IRD flag indicates that the second sub-data field is empty and the acquiring server 112 requests the payment server 116 to determine the IRD value.

Further, the data field C1 corresponds to acquiring BIN data field and the data field C2 corresponds to issuing BIN and remaining data fields comprises for example, but not limited to, MCC, country code, transaction date, a message type indicator (MTI), a transaction amount, a function code, a processing code, a reversal indicator, message reason code, acquiring institution country, a point of sale (POS) data, a universal cardholder authentication field (UCAF) indicator, a service code, transaction currency code, an approval code, and a clearing product ID etc. Please note the sequence of the parameters in the transaction clearing file may vary from what is shown in the FIG. 4B. The first sub-data field C01 may include an identifier with value more than a single value IRD flag for example, but not limited to, “000” or “YYY” or “XXX” etc.

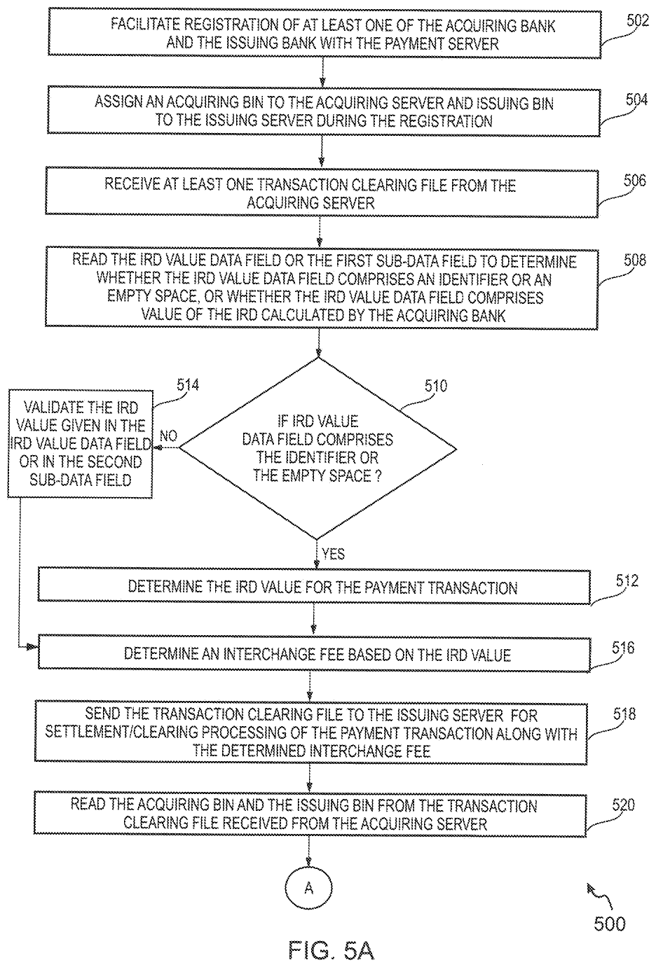

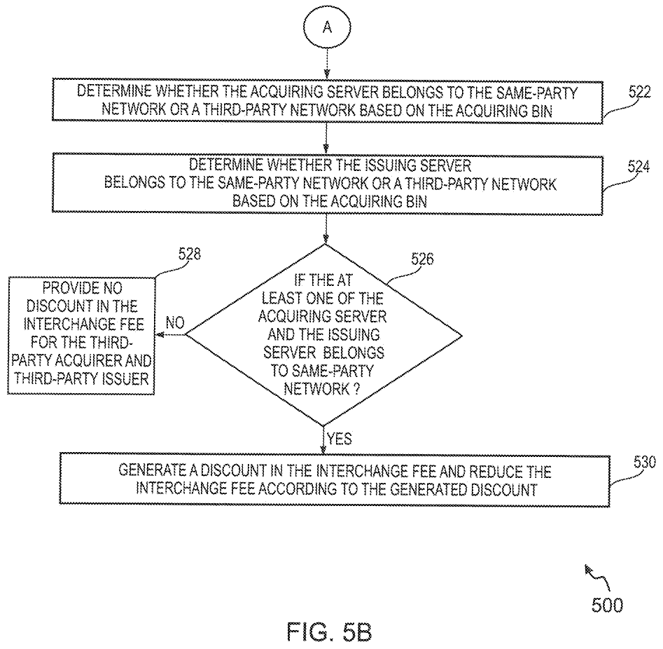

Referring now to FIGS. 5A and 5B, illustrating a flow diagram of a method 500 for making IRD value determination optional for the acquiring bank 112 or the issuing bank 114 and further generating a discount on the interchange fee, in accordance with an example embodiment.

The method 500 depicted in the flow diagram may be executed by a server system which may be the payment server 116. Operations of the flow diagram, and combinations of operation in the flow diagram, may be implemented by, for example, hardware, firmware, a processor, circuitry and/or a different device associated with the execution of software that includes one or more computer program instructions. The operations of the method 500 are described herein with help of the payment server 116, acquiring server 112 and the issuing server 114. It is noted that the operations of the method 500 can be described and/or practiced by using a system other than the payment server 116, acquiring server 112 and the issuing server 114. The method 500 starts at operation 502.

At operation 502, the method 500 includes facilitating, by the payment server 116, registration of at least one of the acquiring bank 112 and the issuing bank 114 with the payment server 116. The acquiring bank 112 and the issuing bank 114 provides information such as operating country, operating region, MCC, type of business of the merchant 102 associated with the acquiring bank 112, etc.

At operation 504, assigning, by the payment server 116, an acquiring BIN to the acquiring server 112 and an issuing BIN to the issuing server 114 during the registration. BINs, which are the first six-digits of the account number, are fundamental to payments. They identify the issuing bank 114 or the acquiring bank 112 for the account and ensure that each transaction is routed correctly. Each payment server 116 has a BIN range from which a BIN is assigned to the acquiring server 112 and issuing server 114 during registration. For example, in a non-limiting manner, Mastercard® has range of 2-series numbers (range 222100-272099) and range of the 5-series numbers (range 510000-559999). Based on the acquiring BIN and issuing BIN, the payment server 116 identifies whether the acquiring server 112 belongs to same-party network or third-party network.

At operation 506, the method 500 includes receiving, by the payment server 116, at least one transaction clearing file from the acquiring server 112. The transaction clearing file (as shown in FIG. 4A or 4B) comprises IRD value data field, acquiring BIN data field, issuing BIN data field and other details related to the payment transaction such as purchase amount, type of product, merchant type, type of payment card, mode of payment etc. The IRD value data field is provided as optional data field and hence IRD value data field can include one of an identifier or an IRD value applicable for the payment transaction or the IRD value data field can be empty. The identifier corresponds to a code indicating the acquiring bank 112 requests to the payment server 116 for determination of the IRD value for the payment transaction. However, in some instances, instead of the identifier the empty IRD value data field can also indicate that the acquiring server 112 is requesting the payment server 116 to determine the IRD value. Hence, the IRD value data field is optional for the acquiring server 112. Similarly, the IRD value data field is optional for the issuing server 114 in cases where the issuing bank sends a transaction clearing/settlement file to the payment server 116 for example, a cashback transaction, a refund processing transaction etc.

Alternatively, or additionally the IRD value data field (as shown in FIG. 4B) further comprises two sub-data fields a first sub-data field and a second sub-data field, wherein the first sub-data field comprises a single value IRD flag whose high value (i.e. value 1 or “Y”) indicates that the second sub-data field contains IRD value which is determined by the acquiring server 112. The low value (i.e. value 0 or “N”) of the IRD flag indicates that the second sub-data field is empty and the acquiring server 112 requests the payment server 116 to determine the IRD value.

At operation 508, the method 500 includes reading, by the payment server 116, the IRD value data field or the first sub-data field to determine whether the IRD value data field comprises an identifier or an empty space. The identifier or the empty space indicates request from the at least one of the acquiring server 112 or the issuing server 114 for computation of the IRD value or whether the IRD value data field comprises value of the IRD calculated by the acquiring bank 112.

At operation 510, if the IRD value data field comprises the identifier or the empty space that indicates request for computation of the IRD value, the method 500 proceeds to operation 512 for determining, by the payment server 116, the IRD value for the payment transaction. Otherwise the method 500 proceeds to operation 514 validating the IRD value given in the IRD value data field or in the second sub-data field.

At operation 516, the method 500 includes determining, by the payment server 116, an interchange fee based on the IRD value. The interchange fee is charged by the payment server 116 from the acquiring server 112 and the issuing server 114 for the services provided by the payment server 116.

At operation 518, the method 500 includes sending, by the payment server 116, the transaction clearing file to the issuing server 114 for settlement/clearing processing of the payment transaction along with the determined interchange fee.

At operation 520, the method 500 includes reading, by the payment server 116, the acquiring BIN and the issuing BIN from the transaction clearing file received from the acquiring server 112.

At operation 522, the method 500 includes determining, by the payment server 116, whether the acquiring server 112 belongs to the same-party network or a third-party network based on the acquiring BIN.

At operation 524, the method 500 includes determining, by the payment server 116, whether the issuing server 114 belongs to the same-party network or a third-party network based on the acquiring BIN.

The payment server 116 identifies whether the acquiring server 112 belongs to same-party network or third-party network based on the acquiring BIN and issuing BIN.

At operation 526, if the at least one of the acquiring server 112 and the issuing server 114 belongs to same-party network, the method 500 proceeds to operation 530 otherwise proceeds to operation 528.

At operation 530, the payment server 116 generates a discount on the interchange fee and reduces the interchange fee charged for the determination of the IRD value if calculated by the payment server 116 and other service provided by the payment server 116. The payment server generates the discount on the interchange fee based on a plurality of parameters such as the transaction amount, operating region of the acquiring server 112 and the issuing server 114, type of payment card 109 used in the payment transaction, etc. A list of discount rates along with different combination of the plurality of parameters can be stored in a table format for easy access or reference for the payment server 116. The payment server reduces the interchange fee charged from the at least one of the acquiring server and the issuing server according to the generated discount.

At operation 528, the payment server 116 provides no discount on the interchange fee for the third-party acquirer and third-party issuer.

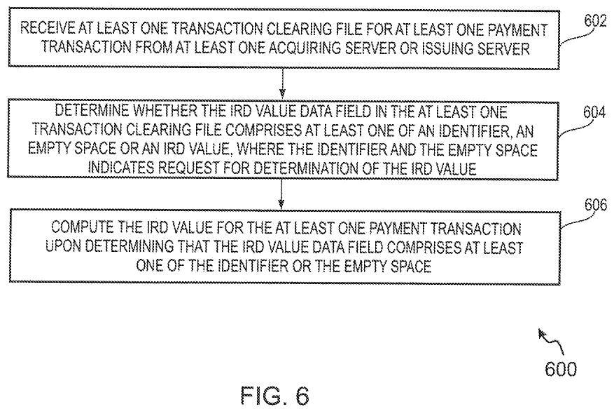

FIG. 6 illustrating another flow diagram of another method 600 for making IRD value determination optional for the acquiring bank 112 or the issuing bank 114, in accordance with an example embodiment. The method 600 depicted in the flow diagram may be executed by a server system which may be the payment server 116. Operations of the flow diagram, and combinations of operation in the flow diagram, may be implemented by, for example, hardware, firmware, a processor, circuitry and/or a different device associated with the execution of software that includes one or more computer program instructions. The operations of the method 600 are described herein with help of the payment server 116, acquiring server 112 and the issuing server 114. It is noted that the operations of the method 600 can be described and/or practiced by using a system other than the payment server 116, acquiring server 112 and the issuing server 114. The method 600 starts at operation 602.

At operation 602, the method 600 includes receiving, by the payment server 116, at least one transaction clearing file from at least one of an acquiring server or an issuing server. The acquiring server is associated with an acquiring bank and the issuing server is associated with an issuing bank. The transaction clearing file (as shown in FIGS. 4A and 4B) comprises IRD value data field, acquiring BIN data field, issuing BIN data field and other details related to the payment transaction such as purchase amount, type of product, merchant type, type of payment card, mode of payment, etc.

At operation 604, the method 600 includes determining, by the payment server 116, whether the IRD value data field in the at least one transaction clearing file comprises at least one of an empty space, an identifier or an IRD value. The identifier and the empty space indicates request for determination of the IRD value. The IRD value data field is provided as an optional data field.

At operation 606, the method 600 includes upon determining that the IRD value data field comprises at least one of the identifier or the empty space, computing the IRD value for the at least one payment transaction.

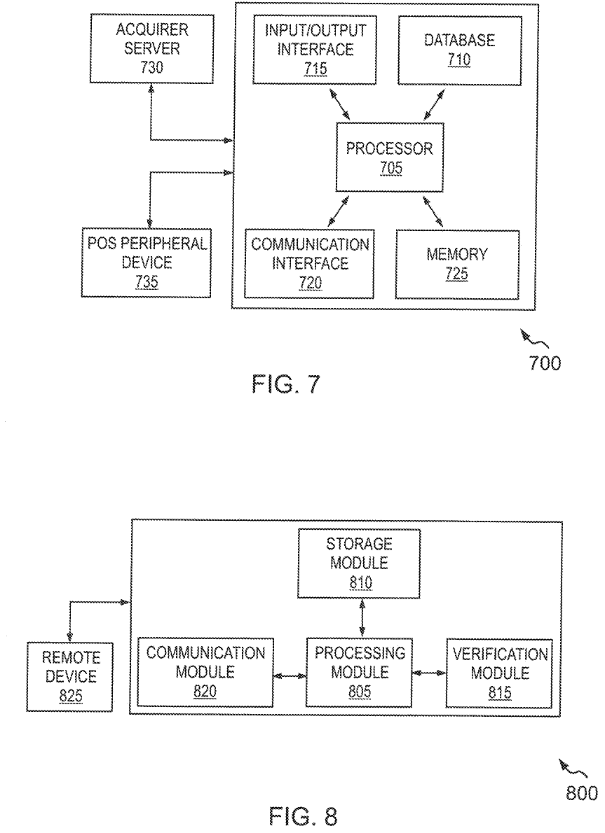

FIG. 7 is a simplified block diagram of a merchant terminal 700 used for making IRD value determination optional for the acquiring bank 112 or the issuing bank 114 and further providing discount on the fees charged from the acquiring bank 112 or the issuing bank 114 by the payment server 116 upon determining that the acquiring bank 112 or the issuing bank 114 belongs to same-party network as the payment server 116, in accordance with one embodiment of the present disclosure. The merchant terminal 700 as explained herein is only one example of the merchant terminal 104. In various embodiments, the merchant terminal 700 can be a merchant mobile phone, a kiosk, a PDA, a merchant facilitated e-commerce website interface running on a computing device and the like. The merchant terminal 700 includes at least one processor 705 communicably coupled to a database 710, an Input/Output (I/O) interface 715, a communication interface 720 and a memory 725. The components of the merchant terminal 700 provided herein may not be exhaustive, and that the merchant terminal 700 may include more or fewer components than that of depicted in FIG. 7. Further, two or more components may be embodied in one single component, and/or one component may be configured using multiple sub-components to achieve the desired functionalities. Some components of the POS terminal 700 may be configured using hardware elements, software elements, firmware elements and/or a combination thereof.

The I/O interface 715 is configured to receive inputs from and provide outputs to the end-user (i.e. the merchant and/or the user) of the merchant terminal 700. For instance, the I/O interface 715 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a UI display (such as a light emitting diode display, a thin-film transistor (TFT) display, a liquid crystal display, an active-matrix organic light-emitting diode (AMOLED) display, etc.), a speaker, a ringer, a vibrator, and the like.

The memory 725 can be any type of storage accessible to the processor 705. For example, the memory 725 may include volatile or non-volatile memories, or a combination thereof. In some non-limiting examples, the memory 725 can be four to sixty four MegaBytes (MB) of Dynamic Random Access Memory (“DRAM”) or Static Random Access Memory (“SRAM”). In addition, some examples may include supplementary flash memory installed via a PCMCIA slot.

The database 710 is capable of storing and/or retrieving data, such as, but not limited to, smart card insertions, user/cardholder information, merchant information, payment strings uniquely associated with each user, touch-screen key depressions, keypad key depressions, number of dots printed by the slip and roll printers, check read errors, card swipes, such as, plurality of number pad values of the payment card 109 and the like. Such information can be accessed by the processor 705 using the communication interface 720 to determine potential future failures and the like.

The merchant terminal 700 is capable of communicating with one or more POS peripheral devices such as a POS peripheral device 735 and external server system such as an acquiring server 730 (an example of the acquiring server 112) via the communication interface 720. The POS peripheral device 735 can provide functionality which is used by a consumer at a merchant facility, such as PIN entry, merchant transaction amount entry, clear text entry, signature capture, and the like. Some non-exhaustive examples of the POS peripheral device 735 include POS card reader device, barcode scanner, cash drawer, receipt printer, PIN pad, signature capture device, touchscreen, keyboard, portable data terminal, cardholder pole display and the like. In some embodiments, the POS terminal 700 may be mounted near a cash register at a check-out counter in the merchant facility, while the POS peripheral device 735 may be mounted on the check-out counter such that it is accessible to the users. In this way, both the merchant and the user/cardholder can interact with similar devices to process the payment transaction.

The communication interface 720 is further configured to cause display of user interfaces on the merchant terminal 700. In one embodiment, the communication interface 720 includes a transceiver for wirelessly communicating information to, or receiving information from, the acquiring server 730 or other suitable display device, and/or another type of remote processing device. In another embodiment, the communication interface 720 is capable of facilitating operative communication with the remote devices and a cloud server using Application Program Interface (API) calls. The communication may be achieved over a communication network.

The processor 705 is capable of sending the transaction request received from the end-user via the communication interface 720 to the acquiring server 730 for processing the transaction. For example, the processor 705 is configured to receive the payment card information of the cardholder 110/124, and the transaction amount via the POS peripheral device 735. The processor 705 can access the database 710 to retrieve the user information and merchant information that are required to be sent along with the transaction request to the acquiring server 112.

Additionally, the merchant terminal 700 can include an operating system and various software applications that can provide various functionality to the merchant terminal 700. For example, in some embodiments, the merchant terminal 700 is addressable with an Internet protocol and includes a browser application. In such embodiments, the processor 705 includes software adapted to support such functionality. In some embodiments, the processor 705 executes software to support network management. In particular, this capacity allows software to be downloaded to a plurality of such systems to provide new applications such as application for enabling payment string-based payment transactions using POS terminals and/or updates to existing applications. The operating system and software application upgrades are distributed and maintained through communication to the merchant terminal 700 over the communication network.

FIG. 8 is a simplified block diagram of an issuing server 800 for making IRD value determination optional for the acquiring bank 112 or the issuing bank 114, in accordance with one embodiment of the present disclosure. The issuing server 800 is an example of the issuing server 114 of FIG. 1 or may be embodied in the issuing server 114. The issuing server 800 is associated with an issuer bank/issuer, in which a cardholder may have an account, which provides a payment card (e.g., the payment card 109). The issuing server 800 includes a processing module 805 operatively coupled to a storage module 810, a verification module 815 and a communication module 820. The components of the issuing server 800 provided herein may not be exhaustive and that the issuing server 800 may include more or fewer components than that of depicted in FIG. 8. Further, two or more components may be embodied in one single component, and/or one component may be configured using multiple sub-components to achieve the desired functionalities. Some components of the issuing server 800 may be configured using hardware elements, software elements, firmware elements and/or a combination thereof.

The storage module 810 is configured to store machine executable instructions to be accessed by the processing module 805. Additionally, the storage module 810 stores information related to, contact information of the users, bank account numbers, availability of funds in the accounts, payment card details, travel information of users, and/or the like. This information is retrieved by the processing module 805 for validation.

The processing module 805 is configured to communicate with one or more remote devices such as a remote device 825 using the communication module 820 over a network such as the payment network 118 of FIG. 1. The examples of the remote device 825 include the merchant terminal 104, the payment server 116, the acquiring server 112, and a central biometric server or other computing systems of issuer and the payment network 118 and the like. The communication module 820 is capable of facilitating such operative communication with the remote devices and cloud servers using API (Application Program Interface) calls. The communication module 820 is configured to receive an authorization request and a transaction clearing file from the payment server 116. Additionally, the communication module 820 is also configured to send the approval message to the payment server 116 via the payment network 118.

The verification module 815 is configured to verify and validate a user (such as the cardholder 110/124), the payment card 109 associated with the cardholder 110/124 and a PIN of the payment card for approving the transaction. The verification module 815 may also verify if an issuer account of the user associated with the payment card have good standing balance. The communication module 820 is configured to send notification of approval or decline of a payment transaction to the merchant terminal 104 via the payment network 118.

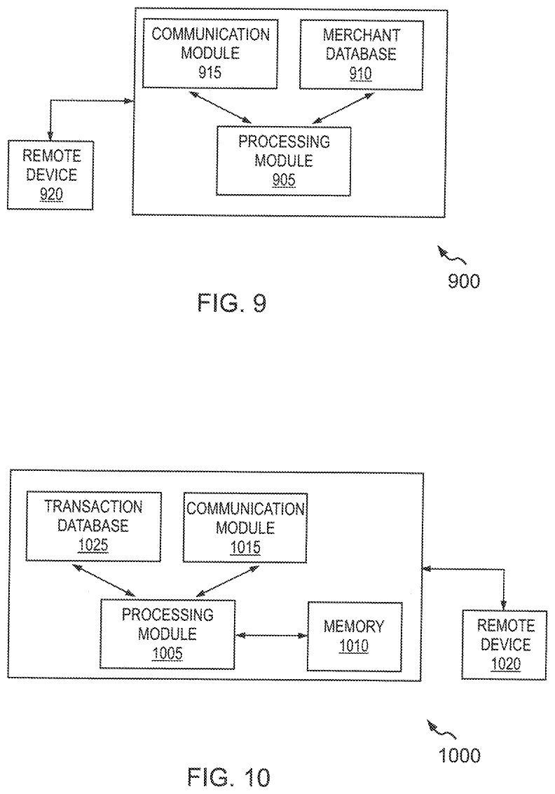

FIG. 9 is a simplified block diagram of an acquiring server 900 for making IRD value determination optional for the acquiring bank or the issuing bank, in accordance with one embodiment of the present disclosure. The acquiring server 900 is associated with an acquirer bank, which may be associated with a merchant (e.g., the merchant facility 102) at whose facility the cardholder 110 is purchasing goods. The merchant may have established an account to accept payment for purchase of goods from the users. The acquiring server 900 is an example of the acquiring server 112 of FIG. 1 or may be embodied in the acquiring server 112. Further, the acquiring server 900 is configured to facilitate transaction with the issuing server 114 using the payment network 118 of FIG. 1. The acquiring server 900 includes a processing module 905 communicably coupled to a merchant database 910 and a communication module 915. The components of the acquiring server 900 provided herein may not be exhaustive, and that the acquiring server 900 may include more or fewer components than that of depicted in FIG. 9. Further, two or more components may be embodied in one single component, and/or one component may be configured using multiple sub-components to achieve the desired functionalities. Some components of the acquiring server 900 may be configured using hardware elements, software elements, firmware elements and/or a combination thereof.

The merchant database 910 includes a table which stores one or more merchant parameters, such as, but not limited to, a merchant primary account number (PAN), a merchant name, a merchant ID (MID), a merchant category code (MCC), a merchant city, a merchant postal code, an MAID, a merchant brand name, terminal identification numbers (TIDs) associated with merchant terminals (e.g., the POS terminals or any other merchant electronic devices) used for processing transactions, among others. The communication module 915 is configured to receive a transaction message from the merchant terminal 104 and the processing module 905 is configured to generate a payment transaction request in response to the transaction message. Moreover, the merchant database 910 is also configured to store the payment transaction request. The processing module 905 is configured to use the MID or any other merchant parameter such as the merchant PAN to identify the merchant during the normal processing of payment transactions, adjustments, chargebacks, end-of-month fees, loyalty programs associated with the merchant and so forth. The processing module 905 may be configured to store and update the merchant parameters in the merchant database 910 for later retrieval. In an embodiment, the communication module 915 is capable of facilitating operative communication with a remote device 920, such as, payment server 116 and acquiring server 112 in the payment network 118. In some example embodiments, the processing module 905 of the acquiring server 900 is configured to generate a batch of transaction messages on end of each business day.

FIG. 10 is a simplified block diagram of a payment server 1000 used for facilitating payment transactions to a merchant, in accordance with an embodiment of the present disclosure. The payment server 1000 is an example of the payment server 116 of FIG. 1. The payment network 118 may be used by the payment server 1000, the issuing server 800 and the acquiring server 900 as a payment interchange network. Examples of payment interchange network include, but not limited to, Mastercard® payment system interchange network. The payment server 1000 includes a processing system 1005 configured to extract programming instructions from a memory 1010 to provide various features of the present disclosure. The components of the payment server 1000 provided herein may not be exhaustive and that the payment server 1000 may include more or fewer components than that of depicted in FIG. 10. Further, two or more components may be embodied in one single component, and/or one component may be configured using multiple sub-components to achieve the desired functionalities. Some components of the payment server 1000 may be configured using hardware elements, software elements, firmware elements and/or a combination thereof.

Via a communication module 1015, the processing system 1005 receives request from a remote device 1020 such as the acquiring server 900. The request may be a payment transaction clearing request from the acquiring server 900. In one example, the processing system 1005 receives the transaction clearing file from the acquiring server 900 via the communication module 1015. The communication may be achieved through API calls, without loss of generality. The payment server 1000 includes a database, such as a transaction database 1025. The transaction database 1025 may include transaction processing data, such as Issuer ID, country code, acquirer ID, among others. In addition, the processing system 1005 may store information of the merchant 102 and the cardholder 110/124.

Without in any way limiting the scope, interpretation, or application of the claims appearing below, a technical effect of one or more of the example embodiments disclosed herein is to provide methods and systems for making IRD value determination optional for the acquiring bank or the issuing bank and further generating discount on the interchange fees charged from acquiring bank or the issuing bank by the payment server upon determining that the acquiring bank or the issuing bank belongs to same-party network as the payment server 116. More specifically, exempting the acquiring servers and the issuing servers from the cumbersome task of determination of IRD value and hence providing the IRD value field in the transaction clearing file as an optional field to the acquiring servers and the issuing servers. Therefore, minimizing the risk of losses incurred due to incorrect IRD determination by the acquiring server and the issuing server and further creating a smooth and precise process for transaction clearing/settlement. Further, the determination of the same-party acquirer and same-party issuer creates a more organized and aware payment transaction system and also provides financial benefit to the acquiring server, issuing server and the payment server. Further, the process of clearing/settlement of payment transaction fastens because of elimination of the IRD determination step by the acquiring server and the issuing serve. The determination of the IRD values becomes more accurate and fast which prevents any financial loss incurred because of late or incorrect submission of IRD value to the payment servers.

The disclosed methods with reference to FIGS. 1 to 10, or one or more operations of the flow diagram 500 and 600 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the disclosure. For example, the various operations, blocks, etc. described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 300 (e.g., the servers 112, 114 and 116) and its various components such as the computer system 305 and the database 310 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A method comprising:
receiving, by a server system, at least one transaction clearing file for at least one payment transaction from at least one of an acquiring server and an issuing server,
wherein the acquiring server is associated with an acquiring bank and the issuing server is associated with an issuing bank, and
wherein the at least one transaction clearing file comprises an interchange rate designator (IRD) value data field, an acquiring bank-identification (BIN) data field, and an issuing BIN data field;
determining, by the server system, whether the IRD value data field in the at least one transaction clearing file comprises at least one of an empty space, an identifier or an IRD value,
wherein the identifier or the empty space indicates request from the at least one of the acquiring server and the issuing server for determination of the IRD value; and
upon determining that the IRD value data field comprises at least one of the identifier or the empty space, computing, by the server system, the IRD value for the at least one payment transaction.

2. The method as claimed in claim 1, further comprising identifying, by the server system whether the at least one of the acquiring bank or the issuing bank is a registered member with the server system, wherein the registered member indicates the at least one of the acquiring bank or the issuing bank is using application provided by the server system.

3. The method as claimed in claim 2, wherein the identifying whether the at least one acquiring bank is the registered member comprises:
reading, by the server system, an acquiring BIN from the acquiring BIN data field of the at least one transaction clearing file; and
matching, by the server system, the acquiring BIN with pre-defined acquiring BIN ranges accessible to the server system.

4. The method as claimed in claim 3, further comprising:
generating, by the server system, a discount on an interchange fee charged from the at least one acquiring bank based on determining that the at least one acquiring bank is the registered member with the system server; and
reducing the interchange fee based on the generated discount.

5. The method as claimed in claim 2, wherein the identifying whether the at least one issuing bank is the registered member comprises:
reading, by the server system, an issuing BIN from the issuing BIN data field of the at least one transaction clearing file; and
matching the issuing BIN with pre-defined issuing BIN ranges accessible to the server system.

6. The method as claimed in claim 5, further comprising:
generating, by the server system, a discount on an interchange fee charged from the at least one issuing bank based on determining that the at least one issuing bank is the registered member with the system server; and
reducing the interchange fee based on the generated discount.

7. The method as claimed in claim 1, wherein computing the IRD value for the at least one payment transaction is based on at least one of a plurality of business service rules, a type of payment transaction, a purchase amount, merchant category codes, a type of a payment card, and a type of product or service purchased in the payment transaction.

8. The method as claimed in claim 1, wherein the IRD value data field comprises an optional field which includes at least one of the empty space and the identifier.

9. The method as claimed in claim 1, further comprising sending, by the server system, the at least one transaction clearing file to the issuing bank.

10. A server system comprising:
a memory to store instructions; and
at least one processor, configured to execute the stored instructions to cause the server system to perform at least:
receiving, by a server system, at least one transaction clearing file for at least one payment transaction from at least one of an acquiring server and an issuing server,
wherein the acquiring server is associated with an acquiring bank and the issuing server is associated with an issuing bank, and
wherein the at least one transaction clearing file comprises an IRD value data field, an acquiring bank-identification (BIN) data field, and an issuing BIN data field;
determining, by the server system, whether the IRD value data field in the at least one transaction clearing file comprises at least one of an empty space, an identifier or an IRD value,
wherein the identifier and the empty space indicates request from the at least one of the acquiring server and the issuing server for determination of the IRD value; and
upon determining that the IRD value data field comprises at least one of the identifier or the empty space, computing, by the server system, the IRD value for the at least one payment transaction.

11. The server system as claimed in claim 10, further caused at least in part to identify whether the at least one of the acquiring bank and the issuing bank is a registered member with the server system, wherein the registered member indicates the at least one of the acquiring bank or the issuing bank is using application provided by the server system.

12. The server system as claimed in claim 11, wherein for identifying whether the at least one acquiring bank is the registered member, the server system is further caused to perform at least:
reading the acquiring BIN from the acquiring BIN data field of the at least one clearing file; and
matching the acquiring BIN with pre-defined acquiring BIN ranges accessible to the server system.

13. The server system as claimed in claim 12, further caused at least in part to:
generate a discount on an interchange fee charged from the at least one at least one acquiring bank based on determining that the at least one acquiring bank is the registered member with the system server; and
reduce the interchange fee based on the generated discount.

14. The server system as claimed in claim 11, wherein for identifying whether the at least one issuing bank is the registered member, the server system is further caused to perform at least:
reading an issuing BIN from the issuing BIN data field of the at least one transaction clearing file; and
matching the issuing BIN with pre-defined issuing BIN ranges accessible to the server system.

15. The server system as claimed in claim 14, further caused at least in part to:
generate a discount on an interchange fee charged from the at least one at least one issuing bank based on determining that the at least one issuing bank is the registered member with the system server; and
reduce the interchange fee based on the generated discount.

16. The server system as claimed in claim 10, wherein computing the IRD value for the at least one payment transaction is based on at least one of a plurality of business service rules, type of payment transaction, a purchase amount, merchant category codes, a type of a payment card, and a type of product or service purchased in the payment transaction.

17. The server system as claimed in claim 10, wherein the IRD value data field corresponds to an optional field which includes at least one of the empty space and the identifier.

18. The server system as claimed in claim 10, further caused at least in part to send the at least one transaction clearing file to the issuing bank.

19. A method comprising:
receiving, by a server system, at least one transaction clearing file for at least one payment transaction from at least one of an acquiring server or an issuing server,
wherein the acquiring server is associated with an acquiring bank and the issuing server is associated with an issuing bank, and
wherein the at least one transaction clearing file comprises an interchange rate designator (IRD) value data field, an acquiring bank-identification (BIN) data field, and an issuing BIN data field;
determining, by the server system, whether the IRD value data field in the at least one transaction clearing file comprises at least one of an empty space, an identifier or a IRD value,
wherein the identifier or the empty space indicates request from the at least one of the acquiring server and the issuing server for determination of the IRD value;
upon determining that the IRD value data field comprises at least one of the identifier or the empty space, computing, by the server system, the IRD value for the at least one payment transaction;
identifying, by the server system, whether the at least one of the acquiring bank and the issuing bank is a registered member with the server system, the registered member being a member using an application service provided by the server system; and
upon identification of registration of the at least one of the acquiring bank and the issuing bank with the system server, generating, by the server system, a discount on an interchange fee charged from the at least one of the acquiring bank and the issuing bank.

20. The method as claimed in claim 19, further comprising reducing the interchange fee based on the generated discount.
